(19) United States
(12) Patent Application Publication
(10) Pub. No.: US 2002/0079261 A1
(43) Pub. Date: Jun. 27, 2002

(54) Membrane element filtration unit

(75) Inventor: Johannes Adrianus Thomassen, Blanes (ES)

Correspondence Address: STEINBERG & RASKIN, P.C., 1140 AVENUE OF THE AMERICAS, 15th FLOOR, NEW YORK, NY, 10036-5803, US

(73) Assignee: MEMBRANE CONCEPTS, S.L.

(21) Appl. No.: 09/991,567

(22) Filed: Nov. 23, 2001

(30) Foreign Application Priority Data
Sep. 7, 2001 (ES) U200102246
Sep. 7, 2001 (ES) U200102242
Nov. 24, 2000 (ES) U200002987

(51) Int. Cl. B01D 63/12

(52) U.S. Cl. 210/321.83; 210/323.2; 210/484; 210/497.01

(57) ABSTRACT

A membrane element filtration unit comprises at least one membrane or filter element, and in the case where the unit comprises two or more membrane or filter elements said elements being coaxially connected to each other by means of interconnecting elements thus forming an assembly, having each of its ends provided with an end member, the assembly being surrounded by a composite glass fiber and resin layer which when hardened forms a rigid cylindrical shell.

### FIELD OF THE INVENTION

This invention relates to membrane element filtration units (“MEFU”) of the type generally used for the filtration of liquids and/or gasses. One of the applications of such MEFU's is in the desalination of seawater.

Several types of membrane or filter elements for use in MEFU's are known and are generally constructed by having cylindrical shaped membranes, such as a spirally wound membrane or a tubular membrane, situated in a cylindrical outer shell to maintain the diameter of the thus-formed cylindrical membrane or filter element.

One or more membrane or filter elements are then placed into a rigid pipe or tube, commonly known as a pressure vessel, having coupling structure at its ends to which end caps or end plates are installed which serve as inlets and outlets for the liquid or gas to form the MEFU. The combination of the membrane elements and the pressure vessel is sometimes referred to as a membrane vessel.

Since the membrane or filter elements and the pressure vessels are manufactured separately, it can become difficult to fit the membrane or filter element precisely into the pressure vessel. A non-perfect fit of a membrane or filter element and vessel will result in a malfunctioning of the membrane vessel or MEFU.

This problem can escalate when two or more cylindrical membrane or filter elements are coaxially interconnected by interconnectors, generally comprising “O” rings, and installed in a single pressure vessel.

### BRIEF SUMMARY OF THE INVENTION

One object of this invention is to provide a new and improved MEFU having increased efficiency.

Another objective of this invention is to provide a new and improved MEFU having low manufacturing cost and containing one or more membrane or filter elements which are interconnected using anti-telescoping device (ATD) interconnecting members.

Briefly, in accordance with the present invention, these and other objects are obtained by tightly wrapping a fiber/resin composite layer around the membrane or filter elements and ATD interconnecting members. After hardening, the fiber/resin composite layer forms a rigid shell around the filter or membrane elements which are snugly fitted to the outer shell, whereby the resulting MEFU functions as a self-contained unit.

Coupling structure is provided at both ends of the MEFU, such as peripherally extending grooves or flanges formed in the shell in order to couple two MEFU's to each other or to couple end caps or end plates to the ends of the MEFU, which may be adapted to serve as inlet and outlet ports for the liquid or gas to be filtered.

In cases in which greater mechanical strength is required in the couplings, an outwardly extending peripheral flange is formed next to each of the peripheral grooves at the ends of the MEFU.

In some cases, for said couplings, the MEFU will be provided only with the peripheral flanges.

According to the invention, the couplings can be improved so that they can be coupled to standard adapters. In this embodiment, the peripheral grooves are formed near the ends of an inner surface of the shell of the MEFU, and in cases in which greater mechanical strength is required, a metal reinforcement is provided in the couplings.

### BRIEF DESCRIPTION OF THE DRAWINGS

These and other features will be readily apparent from the following detailed description when considered in connection with the accompanying drawings showing non-limiting preferred embodiments of the invention and in which,

FIG. 1 shows a longitudinal cross-section view of three membrane or filter elements connected by ATD interconnectors and having ATD end connectors at each end of the resulting structure, and wrapped by tape;

FIG. 2 shows a longitudinal cross-section view of the three membrane or filter element structure of FIG. 1 and a fiber/resin composite tightly wrapped around the membrane or filter elements providing a rigid shell after hardening;

FIG. 3 shows an MEFU in accordance with the invention with coupling structure at each of its ends;

FIG. 4 shows a front view of an ATD interconnector and ATD connector;

FIGS. 5 and 6 show, in diagrammatic longitudinal section and in side view, respectively, the end part of another embodiment of a MEFU according to the invention having a peripheral flange and a peripheral groove;

FIG. 7 shows, in side view, the end part of still another embodiment of a MEFU according to the invention with only a peripheral flange;

FIG. 8 shows, in diagrammatic longitudinal section, the end part of yet another embodiment of a MEFU according to the invention with a groove formed in the inner surface of the shell of the MEFU; and

FIG. 9 shows, in side view, the end part of the MEFU of FIG. 8.

### DETAILED DESCRIPTION OF THE PREFERRED EMBODIMENT

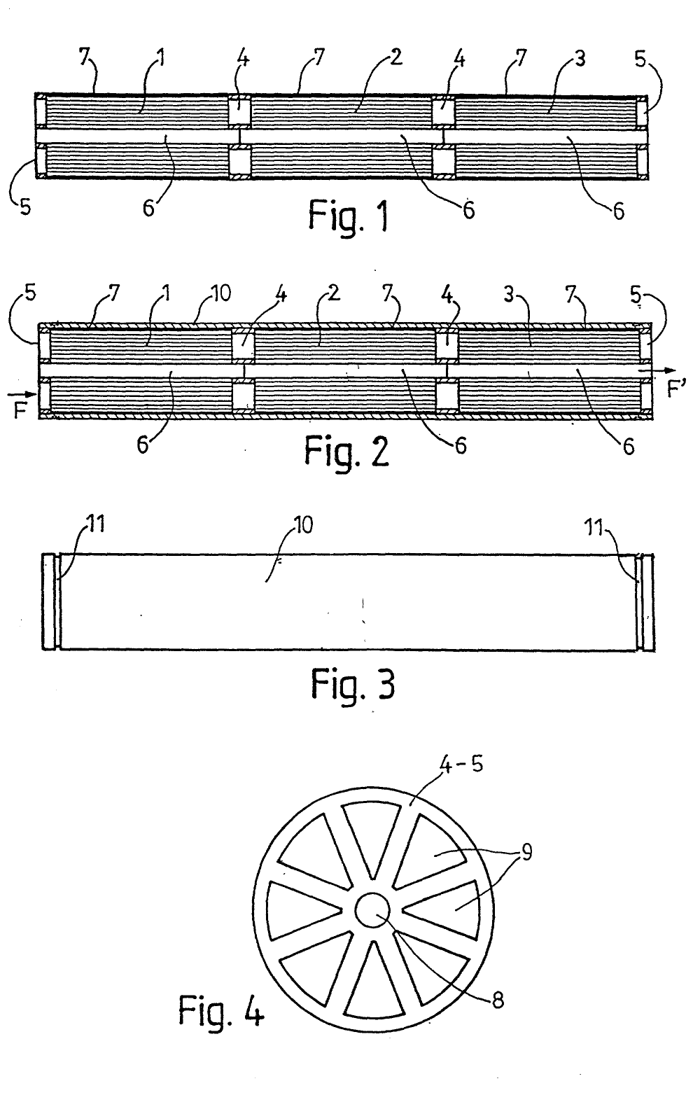

Referring now to the drawings wherein like reference characters designate identical or corresponding parts throughout the several views, and more particularly to FIGS. 1-3, a MEFU in accordance with the invention is illustrated. The MEFU is constructed from several components including three membrane or filter elements 1, 2, 3 connected to each other by means of ATD interconnectors 4 and, at each end, an ATD end connector 5.

In this embodiment, each membrane or filter element 1, 2, 3 is formed by spirally winding a respective membrane around a filtrate tube 6 whereupon tape 7 is wrapped around the periphery of the wound membrane in order to maintain a cylindrical form.

Referring to FIG. 4, the ATD interconnectors 4 and ATD end connectors 5 have a circular form with a central orifice 8 and radial openings 9. The ATD interconnectors and connectors prevent the windings of the membrane or filter elements from sliding or “telescoping” over each other.

The assembly made with the above mentioned components form a cylindrical body which is then covered by a fiber/resin composite layer which when cured, hardens to form a rigid cylindrical outer shell 10 of the MEFU. The fiber/resin composite preferably comprises epoxy resin impregnated with glass fiber. Other fiber/resin composites can be used. Suitable other fibers can be formed from carbon or aramid material and another suitable resin is polyester material.

End caps or end plates (not shown in FIG. 3) are fitted to each of the ends of the assembly and are each provided with one of a respective inlet and outlet for the liquid to be filtered as well as for the discharge of the filtrate.

At each end of the MEFU the shell 10 is provided with coupling structure such as peripherally extending grooves or flanges in order to facilitate the coupling of two MEFU's or the coupling of the end caps or end plates. Referring to FIG. 3, a peripheral groove 11 is formed in the outer surface of the shell 10 at each of the ends of the MEFU.

The above mentioned shell 10 is preferably formed over the membrane or filter elements and connectors by wrapping or winding the resin-impregnated glass filaments around their outer surfaces and allowing the resin to cure to form the hard shell. The thickness of the shell 10 can be adjusted according to the requirements of the filter, notably the pressure requirements for the filter. The thickness of the layer 10 will determine the permissable pressure and temperature operating conditions. The liquid to be filtered flows into the vessel through one of the ends of the vessel as indicated by arrow F and exits at the opposite end as indicated by arrow F'.

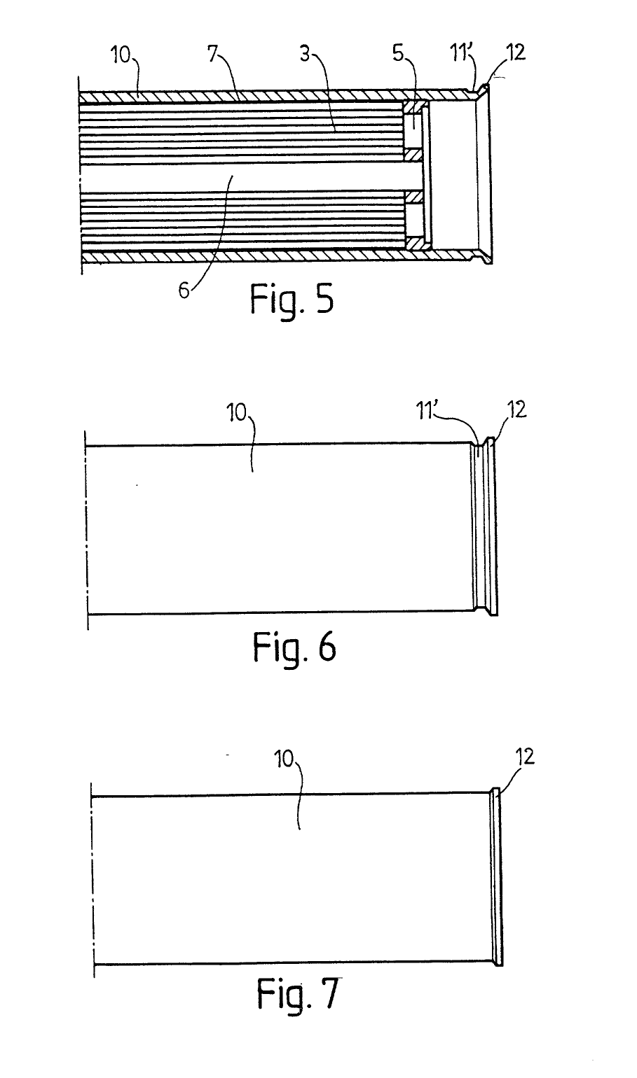

Referring to FIGS. 5 and 6, the end portion of another embodiment of a MEFU according to the invention is shown. The shell 10 of this embodiment of the MEFU is formed so as to project a distance beyond the end of the ATD end connector 5 attached to the end of membrane element 3. The fiber/resin composite may be wrapped over a suitable removable cylindrical mandrel to form the projecting portion of the shell. A circumferentially extending peripheral groove 11′ is formed in the outer surface the end portion of shell 10 and an outwardly extending flange 12 is formed at the end of the shell for coupling of caps or end plates to the filtration unit or for coupling of adapter pieces between two MEFU's. Another embodiment of an MEFU according to the invention is shown in FIG. 7 in which the end of the shell 10 is provided only with a flange 12, i.e., no groove is formed in either the inner or outer surfaces of the shell.

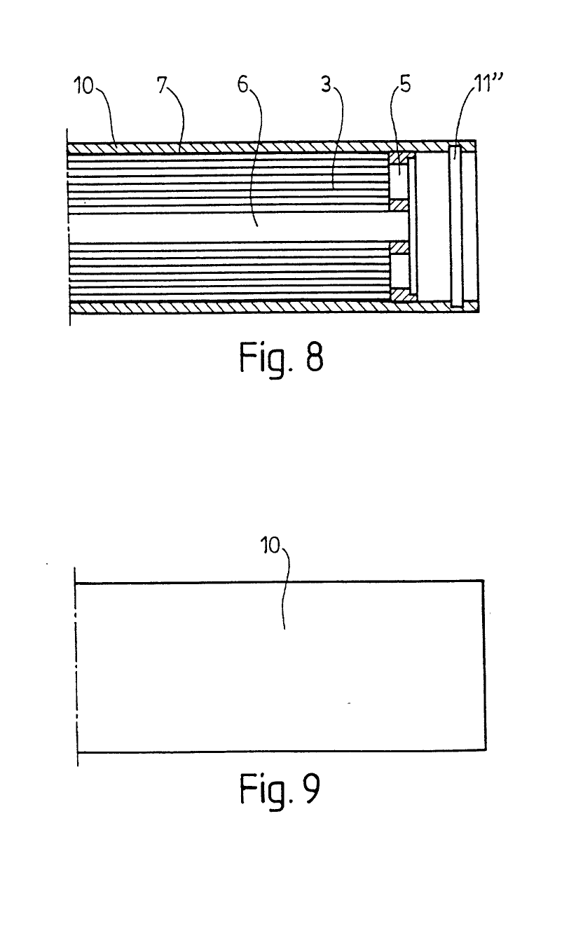

Referring to FIGS. 8 and 9, another embodiment of an MEFU according to the invention is shown in which a peripheral groove 11″ is formed on the inner surface of a projecting end region of shell 10 for coupling to the adapter pieces.

Obviously, numerous modifications and variations of the present invention are possible in the light of the above disclosure. It is therefore understood that the invention may be practiced otherwise than as specifically disclosed herein within the scope of the claims attached hereto.

I claim:

1. A membrane element filtration unit comprising at least one membrane element coaxially arranged with respect to each other, any pair of adjacent membrane elements being coaxially interconnected by anti-telescoping device interconnectors, anti-telescoping device end connectors coupled to each end of the unit, and a fiber/resin composite layer wrapped around said at least one membrane element, said composite layer being cured to form a substantially cylindrical rigid outer shell.

2. A membrane element filtration unit as recited in claim 1 further comprising a coupling mechanism formed at each end of said shell to facilitate the coupling of two or more filtration units as well as the coupling of one or more filtration units to adapter pieces.

3. A membrane element filtration unit as recited in claim 2 wherein said coupling mechanism comprises a groove formed in the outer surface of said shell.

4. A membrane element filtration unit as recited in claim 1 wherein a peripheral flange is formed at each of the ends of said shell to facilitate coupling between two filtration units and adapter pieces.

5. A membrane element filtration unit as recited in claim 4 wherein a peripheral groove is formed in the outer surface of each of the ends of said shell proximate to a respective peripheral flange.

6. A membrane element filtration unit as recited in claim 1 wherein a peripheral groove is formed in an inner surface of each of the end regions of said shell to facilitate coupling between two filtration units and adapter pieces.

7. A membrane element filtration unit comprising at least two membrane elements having an outer surface, end connectors coupled to each end of said unit, and a fiber/resin composite layer wrapped around said at least one membrane element, said composite layer being cured to form a rigid outer shell.
